(19) United States
(12) Patent Application Publication
(10) Pub. No.: US 2023/0149815 A1
(43) Pub. Date: May 18, 2023

(54) METHOD FOR PROVIDING BATTLE ROYALE GAME WHICH ALLOWS PLAYERS TO REPAIR PROTECTIVE ITEMS FOR SURVIVAL AND SERVER USING THE SAME

(71) Applicant: Wonder People Co., Ltd., Seoul (KR)

(72) Inventor: Min HUR, Seoul (KR)

(21) Appl. No.: 17/944,243

(22) Filed: Sep. 14, 2022

(30) Foreign Application Priority Data
Nov. 15, 2021 (KR) 10-2021-0157120
Jun. 16, 2022 (KR) 10-2022-0073831

(51) Int. Cl. A63F 13/58; A63F 13/35; A63F 13/537

(52) U.S. Cl. CPC A63F 13/58; A63F 13/35; A63F 13/537

(57) ABSTRACT

Method for allowing to repair the protective items and a server is provided. The method includes steps of: (a) on condition that information on each of a 1-st protective item to an n-th protective item, information on at least one 1-st material item to at least one n-th material item and 1-st hierarchy information to n-th hierarchy information have been managed, acquiring a repair request for a specific protective item from a specific user terminal corresponding to a specific player; and (b) determining whether a condition for repairing the specific protective item is satisfied by referring to at least part of information on at least one possessed repairing item and information on possessed material item of the specific player, and in response to determining that the condition for repairing the specific protective item is satisfied, repairing the specific protective item of the specific player.

### CROSS REFERENCE TO RELATED APPLICATION

This application claims the benefit of priority to Korean Provisional Patent Application No. 10-2021-0157120, filed on Nov. 15, 2021 and Korean Patent Application No. 10-2022-0073831, filed on Jun. 16, 2022, the entire contents of which being incorporated herein by reference.

### FIELD OF THE DISCLOSURE

The present disclosure relates to a method for providing a battle royale game and a server using the same; and more particularly, to the method for providing a battle royale game which allows the players to repair the protective items for survival of players participating in the battle royale game, and the server using the same.

### BACKGROUND OF THE DISCLOSURE

Numerous battle royale games which can be played by multiple users at the same time are recently being released, and are gaining popularity steadily from the users.

Such battle royale games are allowing the multiple players to compete for survival to be a final winner in a restricted space, and the users feel interest in preoccupying geographical advantages and items and establishing appropriate strategies or tactics according thereto, thereby overpowering competitors.

However, the players participating in the conventional battle royale games were unable to repair protective items spawned in a battle-possible area, i.e., field.

Accordingly, as disabilities of previously acquired protective items are exhausted due to repeated battles, defense capacities of the protective items are lost, and thus the players participating in the battle royale games had to search for new protective items, or had to be in the competition for survival without wearing their protective items.

However, due to characteristics of the battle royale games, powers of weapons equipped by the players are increased by lapse of time, whereas the number of the protective items that can be acquired newly by the players is rapidly decreased in number by lapse of time. Thus there is a problem that some players who lost the defense capacities had to die like flies in the survival competition in the battle royale games.

Accordingly, a configuration for solving the problems above is demanded in this situation.

### SUMMARY OF THE DISCLOSURE

It is an object of the present disclosure to solve all the aforementioned problems.

It is another object of the present disclosure to support players participating in a battle royale game to be capable of repairing protective items necessary for survival by using various items.

It is still another object of the present disclosure to support the players to determine a manner of repairing the protective items in response to various situations occurring in the battle royale game, to thereby support the players to be capable of repairing the protective items through a suitable repairing manner for their own current situations.

It is still yet another object of the present disclosure to provide various information on the protective items necessary for survival to the players through various visual effects.

It is still yet another object of the present disclosure to impart a special skill to a repaired protective item, thereby preventing the players of the battle royale game from losing interest easily.

In accordance with one aspect of the present disclosure, there is provided a method for providing a battle royale game which allows the players to repair the protective items, including steps of: (a) on condition that information on each of a 1-st protective item to an n-th protective item, information on at least one 1-st material item corresponding to the 1-st protective item to at least one n-th material item corresponding to the n-th protective item, wherein each of the 1-st material item to the n-th material item to be consumed respectively for upgrading each of the 1-st protective item to the n-th protective item includes at least part of (i) each of a (1_1)-st material item to an (n_1)-st material item directly consumed respectively for upgrading each of the 1-st protective item to the n-th protective item and (ii) each of a (1_2)-nd material item to an (n_2)-nd material item indirectly consumed respectively for upgrading each of the 1-st protective item to the n-th protective item, and 1-st hierarchy information to n-th hierarchy information, wherein each of the 1-st hierarchy information to the n-th hierarchy information includes each of information on hierarchy between each of levels of the 1-st protective item and each of levels of the 1-st material item to information on hierarchy between each of levels of the n-th protective item and each of levels of the n-th material item, have been stored and managed in a database, a server acquiring a repair request for a specific protective item from a specific user terminal corresponding to a specific player among a plurality of players participating in the battle royale game; and (b) the server determining whether a condition for repairing the specific protective item is satisfied by referring to at least part of information on at least one possessed repairing item and information on possessed material item of the specific player, and in response to determining that the condition for repairing the specific protective item is satisfied, repairing the specific protective item of the specific player, wherein the information on the possessed repairing item is information on an item consumed for repairing at least part of the 1-st protective item to the n-th protective item, and wherein the information on the possessed material item is information on an item consumed for upgrading at least part of the 1-st protective item to the n-th protective item.

As one example, there is provided a method, wherein, at the step of (a), the server provides at least one of a 1-st repair mode UI and a 2-nd repair mode UI to the specific user terminal, and thus acquires any one of a 1-st repair request corresponding to the 1-st repair mode UI and a 2-nd repair request corresponding to the 2-nd repair mode UI as the repair request for the specific protective item from the specific user terminal, wherein the 1-st repair mode UI is a user interface provided for directly allowing the specific protective item to be repaired by consuming at least part of the possessed repairing item of the specific player, and wherein the 2-nd repair mode UI is a user interface provided for indirectly allowing the specific protective item to be repaired by consuming at least part of the possessed material item of the specific player and thus by upgrading the specific protective item, and wherein, at the step of (b), the server performs any one of (i) a direct repairing process of (i-1) determining whether a condition for repairing a 1-st specific protective item as the condition for repairing the specific protective item is satisfied by referring to at least part of the possessed repairing item and (i-2) in response to determining that the condition for repairing the 1-st specific protective item is satisfied, directly repairing the specific protective item by consuming at least part of the possessed repairing item of the specific player, in case the 1-st repair request is acquired, according to a 1-st repair mode corresponding to the 1-st repair request and (ii) an indirect repairing process of (ii-1) determining whether a condition for repairing a 2-nd specific protective item as the condition for repairing the specific protective item is satisfied by referring to (ii-1-a) at least part of information on the 1-st protective item to the n-th protective item, information on the 1-st material item to the n-th material item and the 1-st hierarchy information to the n-th hierarchy information and (ii-1-b) at least part of the possessed material item, and (ii-2) in response to determining that the condition for repairing the 2-nd specific protective item is satisfied, indirectly repairing the specific protective item by consuming at least part of the possessed material item of the specific player and thus by upgrading the specific protective item, in case the 2-nd repair request is acquired, according to a 2-nd repair mode corresponding to the 2-nd repair request. As one example, there is provided a method, wherein, at the step of (a), the server provides a 1-st repair mode UI and a 2-nd repair mode UI to the specific user terminal, wherein the 1-st repair mode UI is a user interface provided for directly allowing the specific protective item to be repaired by consuming at least part of the possessed repairing item of the specific player, and wherein the 2-nd repair mode UI is a user interface provided for indirectly allowing the specific protective item to be repaired by consuming at least part of the possessed material item of the specific player and thus by upgrading the specific protective item, and thus acquires a 1-st repair request corresponding to the 1-st repair mode UI and a 2-nd repair request corresponding to the 2-nd repair mode UI as the repair request for the specific protective item from the specific user terminal, and wherein, at the step of (b), the server determines a specific repair mode among the 1-st repair mode and the 2-nd repair mode by referring to (i) at least part of the possessed repairing item and the possessed material item, (ii) a 1-st process-performing probability which represents a probability of performing a direct repairing process directly repairing the specific protective item according to a 1-st repair mode corresponding to the 1-st repair request and (iii) a 2-nd process-performing probability which represents a probability of performing an indirect repairing process indirectly repairing the specific protective item according to a 2-nd repair mode corresponding to the 2-nd repair request, wherein, in case the 1-st repair mode is determined as the specific repair mode, in response to determining that a condition for repairing a 1-st specific protective item as the condition for repairing the specific protective item is satisfied by referring to at least part of the possessed repairing item, the server performs the direct repairing process directly repairing the specific protective item by consuming at least part of the possessed repairing item of the specific player, and wherein, in case the 2-nd repair mode is determined as the specific repair mode, in response to determining that a condition for repairing a 2-nd specific protective item as the condition for repairing the specific protective item is satisfied by referring to (i) at least part of information on the 1-st protective item to the n-th protective item, information on the 1-st material item to the n-th material item and the 1-st hierarchy information to the n-th hierarchy information and (ii) at least part of the possessed material item, the server performs the indirect repairing process indirectly repairing the specific protective item by consuming at least part of the possessed material item of the specific player and thus by upgrading the specific protective item.

As one example, there is provided a method, wherein a k-th protective item among the 1-st protective item to the n-th protective item includes a (k_1)-th level protective item to a (k_mk)-th level protective item, where k is an integer of 1 to n, and wherein a k-th material item among the 1-st material item to the n-th material item includes at least part of a (k_1_1)-st material item directly consumed for upgrading the (k_1)-st level protective item and a (k_2_1)-st material item indirectly consumed for upgrading the (k_1)-st level protective item, at least part of a (k_1_2)-nd material item directly consumed for upgrading the (k_2)-nd level protective item and a (k_2_2)-nd material item indirectly consumed for upgrading the (k_2)-nd level protective item, . . . , and at least part of a (k_1_(m−1)k)-th material item directly consumed for upgrading the (k_(m−1)k)-th level protective item and a (k_2_(m−1)k)-th material item indirectly consumed for upgrading the (k_(m−1)k)-th level material item.

As one example, there is provided a method, wherein, at the step of (a), the server acquires a repair request for a (k_(j−1)k)-th level protective item among the (k_1)-th level protective item to (k_(m−1)k)-th level protective item as the repair request for the specific protective item from the specific user terminal, where j is an integer of 1 to m, and wherein, at the step of (b), the server determines whether a condition for repairing the (k_(j−1)k)-th level protective item as the condition for repairing the specific protective item is satisfied by referring to (i) at least part of information on the 1-st protective item to the n-th protective item, information on the 1-st material item to the n-th material item and the 1-st hierarchy information to the n-th hierarchy information and (ii) at least part of information on the possessed material item, and in response to determining that the condition for repairing the (k_(j−1)k-th level protective item is satisfied, repairs the (k_(j−1)k)-th level protective item by upgrading the (k_(j−1)k)-th level protective item of the specific player to (k_jk)-th level protective item, and wherein the server (1) determines a special skill imparting probability by referring to game progress level information, wherein, on condition that a state of the plurality of players waiting in a waiting space in the battle royale game is a 1-st state, and a state of the plurality of players playing in the battle royale game is a 2-nd state, the game progress level information is calculated by using a progress level calculating function having arguments of at least part of elapsed time information which represents a time elapsed after the battle royale game enters the 2-nd state, player battle power information which represents a battle power of at least part of the plurality of players, area phase information which represents a state of a safe area and a dangerous area being changed according to area metadata, a cardinal number of surviving players among the plurality of players and possessed item of the surviving players, and (2) imparts a specific special skill among s special skills to the (k_jk)-th level protective item according to the special skill imparting probability, where s is an integer of 1 or more.

As one example, there is provided a method, wherein, at the step of (b), in case the specific special skill is imparted to the (k_(j_1)k)-th level protective item, the server further imparts an additional special skill among (s−1) special skills excluding the specific special skill to the (k_jk)-th level protective item according to the special skill imparting probability.

As one example, there is provided a method, wherein, at the step of (a), on condition that information on a 1-st threshold durability to information on an n-th threshold durability respectively corresponding to the 1-st protective item to the n-th protective item have been stored and managed in the database, in response to acquiring information on a current durability corresponding to the specific protective item from the specific user terminal, the server compares the current durability with a specific threshold durability of the specific protective item, and in response to determining that the current durability is less than or equal to the specific threshold durability, the server transmits information on a defense capacity loss which represents that a defense capacity of the specific protective item is lost to the specific user terminal, thereby supporting the specific user terminal to transmit the repair request for the specific protective item by referring to the information on the defense capacity loss.

As one example, there is provided a method, wherein, at the step of (a), on condition that information on 1-st class synergetic protective item to j-th class synergetic protective item respectively corresponding to a 1-st class to a j-th class have been further stored and managed in the database through a process of matching an i-th class synergetic protective item to an i-th class, where i is an integer of 1 to j, and wherein the 1-st class synergetic protective item to the j-th class synergetic protective item are respectively any ones of the 1-st protective item to the n-th protective item, and wherein the 1-st class synergetic protective item to the j-th class synergetic protective item are items capable of improving performances thereof in case they are used by at least one 1-st player to at least one j-th player respectively corresponding to the 1-st class to the j-th class, the server acquires a repair request for a specific class synergetic protective item corresponding to a specific class applied to the specific player as the repair request for the specific protective item from the specific user terminal, and wherein, at the step of (b), the server determines whether a condition for repairing the specific class synergetic protective item by referring to at least part of the possessed repair item and the possessed material item of the specific player, and in response to determining that the condition for repairing the specific class synergetic protective item is satisfied, the server repairs the specific class synergetic protective item of the specific player.

In accordance with another aspect of the present disclosure, there is provided a server for providing a battle royale game which allows the players to repair the protective items, including: at least one memory that stores instructions; and at least one processor configured to execute the instructions to perform or support another device to perform processes of: (I) on condition that information on each of a 1-st protective item to an n-th protective item, information on at least one 1-st material item corresponding to the 1-st protective item to at least one n-th material item corresponding to the n-th protective item, wherein each of the 1-st material item to the n-th material item to be consumed respectively for upgrading each of the 1-st protective item to the n-th protective item includes at least part of (i) each of a (1_1)-st material item to an (n_1)-st material item directly consumed respectively for upgrading each of the 1-st protective item to the n-th protective item and (ii) each of a (1_2)-nd material item to an (n_2)-nd material item indirectly consumed respectively for upgrading each of the 1-st protective item to the n-th protective item, and 1-st hierarchy information to n-th hierarchy information, wherein each of the 1-st hierarchy information to the n-th hierarchy information includes each of information on hierarchy between each of levels of the 1-st protective item and each of levels of the 1-st material item to information on hierarchy between each of levels of the n-th protective item and each of levels of the n-th material item, have been stored and managed in a database, acquiring a repair request for a specific protective item from a specific user terminal corresponding to a specific player among a plurality of players participating in the battle royale game; and (II) determining whether a condition for repairing the specific protective item is satisfied by referring to at least part of information on at least one possessed repairing item and information on possessed material item of the specific player, and in response to determining that the condition for repairing the specific protective item is satisfied, repairing the specific protective item of the specific player, wherein the information on the possessed repairing item is information on an item consumed for repairing at least part of the 1-st protective item to the n-th protective item, and wherein the information on the possessed material item is information on an item consumed for upgrading at least part of the 1-st protective item to the n-th protective item.

As one example, there is provided a server, wherein, at the process of (I), the processor provides at least one of a 1-st repair mode UI and a 2-nd repair mode UI to the specific user terminal, and thus acquires any one of a 1-st repair request corresponding to the 1-st repair mode UI and a 2-nd repair request corresponding to the 2-nd repair mode UI as the repair request for the specific protective item from the specific user terminal, wherein the 1-st repair mode UI is a user interface provided for directly allowing the specific protective item to be repaired by consuming at least part of the possessed repairing item of the specific player, and wherein the 2-nd repair mode UI is a user interface provided for indirectly allowing the specific protective item to be repaired by consuming at least part of the possessed material item of the specific player and thus by upgrading the specific protective item, and wherein, at the process of (II), the processor performs any one of (i) a direct repairing process of (i-1) determining whether a condition for repairing a 1-st specific protective item as the condition for repairing the specific protective item is satisfied by referring to at least part of the possessed repairing item and (i-2) in response to determining that the condition for repairing the 1-st specific protective item is satisfied, directly repairing the specific protective item by consuming at least part of the possessed repairing item of the specific player, in case the 1-st repair request is acquired, according to a 1-st repair mode corresponding to the 1-st repair request and (ii) an indirect repairing process of (ii-1) determining whether a condition for repairing a 2-nd specific protective item as the condition for repairing the specific protective item is satisfied by referring to (ii-1-a) at least part of information on the 1-st protective item to the n-th protective item, information on the 1-st material item to the n-th material item and the 1-st hierarchy information to the n-th hierarchy information and (ii-1-b) at least part of the possessed material item, and (ii-2) in response to determining that the condition for repairing the 2-nd specific protective item is satisfied, indirectly repairing the specific protective item by consuming at least part of the possessed material item of the specific player and thus by upgrading the specific protective item, in case the 2-nd repair request is acquired, according to a 2-nd repair mode corresponding to the 2-nd repair request.

As one example, there is provided a server, wherein, at the process of (I), the processor provides a 1-st repair mode UI and a 2-nd repair mode UI to the specific user terminal, wherein the 1-st repair mode UI is a user interface provided for directly allowing the specific protective item to be repaired by consuming at least part of the possessed repairing item of the specific player, and wherein the 2-nd repair mode UI is a user interface provided for indirectly allowing the specific protective item to be repaired by consuming at least part of the possessed material item of the specific player and thus by upgrading the specific protective item, and thus acquires a 1-st repair request corresponding to the 1-st repair mode UI and a 2-nd repair request corresponding to the 2-nd repair mode UI as the repair request for the specific protective item from the specific user terminal, and wherein, at the process of (II), the processor determines a specific repair mode among the 1-st repair mode and the 2-nd repair mode by referring to (i) at least part of the possessed repairing item and the possessed material item, (ii) a 1-st process-performing probability which represents a probability of performing a direct repairing process directly repairing the specific protective item according to a 1-st repair mode corresponding to the 1-st repair request and (iii) a 2-nd process-performing probability which represents a probability of performing an indirect repairing process indirectly repairing the specific protective item according to a 2-nd repair mode corresponding to the 2-nd repair request, wherein, in case the 1-st repair mode is determined as the specific repair mode, in response to determining that a condition for repairing a 1-st specific protective item as the condition for repairing the specific protective item is satisfied by referring to at least part of the possessed repairing item, the processor performs the direct repairing process directly repairing the specific protective item by consuming at least part of the possessed repairing item of the specific player, and wherein, in case the 2-nd repair mode is determined as the specific repair mode, in response to determining that a condition for repairing a 2-nd specific protective item as the condition for repairing the specific protective item is satisfied by referring to (i) at least part of information on the 1-st protective item to the n-th protective item, information on the 1-st material item to the n-th material item and the 1-st hierarchy information to the n-th hierarchy information and (ii) at least part of the possessed material item, the processor performs the indirect repairing process indirectly repairing the specific protective item by consuming at least part of the possessed material item of the specific player and thus by upgrading the specific protective item.

As one example, there is provided a server, wherein a k-th protective item among the 1-st protective item to the n-th protective item includes a (k_1)-th level protective item to a (k_mk)-th level protective item, where k is an integer of 1 to n, and wherein a k-th material item among the 1-st material item to the n-th material item includes at least part of a (k_1_1)-st material item directly consumed for upgrading the (k_1)-st level protective item and a (k_2_1)-st material item indirectly consumed for upgrading the (k_1)-st level protective item, at least part of a (k_1_2)-nd material item directly consumed for upgrading the (k_2)-nd level protective item and a (k_2_2)-nd material item indirectly consumed for upgrading the (k_2)-nd level protective item, . . . , and at least part of a (k_1_(m−1)k)-th material item directly consumed for upgrading the (k_(m−1)k)-th level protective item and a (k_2_(m−1)k)-th material item indirectly consumed for upgrading the (k_(m−1)k)-th level material item.

As one example, there is provided a server, wherein, at the process of (I), the processor acquires a repair request for a (k_(j−1)k)-th level protective item among the (k_1)-th level protective item to (k_(m−1)k)-th level protective item as the repair request for the specific protective item from the specific user terminal, where j is an integer of 1 to m, and wherein, at the process of (II), the processor determines whether a condition for repairing the (k_(j−1)k)-th level protective item as the condition for repairing the specific protective item is satisfied by referring to (i) at least part of information on the 1-st protective item to the n-th protective item, information on the 1-st material item to the n-th material item and the 1-st hierarchy information to the n-th hierarchy information and (ii) at least part of information on the possessed material item, and in response to determining that the condition for repairing the (k_(j−1)k-th level protective item is satisfied, repairs the (k_(j−1)k)-th level protective item by upgrading the (k_(j−1)k)-th level protective item of the specific player to (k_jk)-th level protective item, and wherein the processor (I) determines a special skill imparting probability by referring to game progress level information, wherein, on condition that a state of the plurality of players waiting in a waiting space in the battle royale game is a 1-st state, and a state of the plurality of players playing in the battle royale game is a 2-nd state, the game progress level information is calculated by using a progress level calculating function having arguments of at least part of elapsed time information which represents a time elapsed after the battle royale game enters the 2-nd state, player battle power information which represents a battle power of at least part of the plurality of players, area phase information which represents a state of a safe area and a dangerous area being changed according to area metadata, a cardinal number of surviving players among the plurality of players and possessed item of the surviving players, and (II) imparts a specific special skill among s special skills to the (k_jk)-th level protective item according to the special skill imparting probability, where s is an integer of 1 or more.

As one example, there is provided a server, wherein, at the process of (II), in case the specific special skill is imparted to the (k_(j_1)k)-th level protective item, the processor further imparts an additional special skill among (s−1) special skills excluding the specific special skill to the (k_jk)-th level protective item according to the special skill imparting probability.

As one example, there is provided a server, wherein, at the process of (I), on condition that information on a 1-st threshold durability to information on an n-th threshold durability respectively corresponding to the 1-st protective item to the n-th protective item have been stored and managed in the database, in response to acquiring information on a current durability corresponding to the specific protective item from the specific user terminal, the processor compares the current durability with a specific threshold durability of the specific protective item, and in response to determining that the current durability is less than or equal to the specific threshold durability, the processor transmits information on a defense capacity loss which represents that a defense capacity of the specific protective item is lost to the specific user terminal, thereby supporting the specific user terminal to transmit the repair request for the specific protective item by referring to the information on the defense capacity loss.

As one example, there is provided a server, wherein, at the process of (I), on condition that information on 1-st class synergetic protective item to j-th class synergetic protective item respectively corresponding to a 1-st class to a j-th class have been further stored and managed in the database through a process of matching an i-th class synergetic protective item to an i-th class, where i is an integer of 1 to j, and wherein the 1-st class synergetic protective item to the j-th class synergetic protective item are respectively any ones of the 1-st protective item to the n-th protective item, and wherein the 1-st class synergetic protective item to the j-th class synergetic protective item are items capable of improving performances thereof in case they are used by at least one 1-st player to at least one j-th player respectively corresponding to the 1-st class to the j-th class, the processor acquires a repair request for a specific class synergetic protective item corresponding to a specific class applied to the specific player as the repair request for the specific protective item from the specific user terminal, and wherein, at the process of (II), the processor determines whether a condition for repairing the specific class synergetic protective item by referring to at least part of the possessed repair item and the possessed material item of the specific player, and in response to determining that the condition for repairing the specific class synergetic protective item is satisfied, the processor repairs the specific class synergetic protective item of the specific player.

### BRIEF DESCRIPTION OF THE DRAWINGS

The accompanying drawings used to explain example embodiments of the present disclosure are only part of example embodiments of the present disclosure and other drawings can be obtained based on the drawings by those skilled in the art of the present disclosure without inventive work.

FIG. 1 is a drawing representing a schematic configuration of a server for providing a battle royale game which allows the players to repair the protective items for survival in accordance with one example embodiment of the present disclosure.

FIG. 2 is a drawing representing a flowchart for providing the battle royale game which allows players to repair the protective items for survival in accordance with one example embodiment of the present disclosure.

FIG. 3 is a drawing representing a schematic illustration of protective items, material items and hierarchy information thereamong in accordance with one example embodiment of the present disclosure.

### DETAILED DESCRIPTION OF THE PREFERRED EMBODIMENTS

In the following detailed description, reference is made to the accompanying drawings that show, by way of illustration, specific embodiments in which the invention may be practiced. These embodiments are described in sufficient detail to enable those skilled in the art to practice the invention.

Besides, in the detailed description and claims of the present disclosure, a term “include” and its variations are not intended to exclude other technical features, additions, components or steps. Other objects, benefits and features of the present disclosure will be revealed to one skilled in the art, partially from the specification and partially from the implementation of the present disclosure. The following examples and drawings will be provided as examples but they are not intended to limit the present disclosure.

Furthermore, the present invention includes all possible combinations of embodiments indicated in the present disclosure. It is to be understood that the various embodiments of the present disclosure, although different, are not necessarily mutually exclusive. For example, a particular feature, structure, or characteristic described herein in connection with one embodiment may be implemented within other embodiments without departing from the spirit and scope of the present disclosure. In addition, it is to be understood that the position or arrangement of individual elements within each disclosed embodiment may be modified without departing from the spirit and scope of the present disclosure. The following detailed description is, therefore, not to be taken in a limiting sense, and the scope of the present disclosure is defined only by the appended claims, appropriately interpreted, along with the full range of equivalents to which the claims are entitled. In the drawings, like numerals refer to the same or similar functionality throughout the several views.

The title of the present invention or the abstract provided herein are provided just for convenience, and they are not to restrict or interpret the scope or meaning of these embodiments.

Hereinafter, to allow those skilled in the art to the present disclosure to be carried out easily, the example embodiments of the present disclosure by referring to attached diagrams will be explained in detail as shown below.

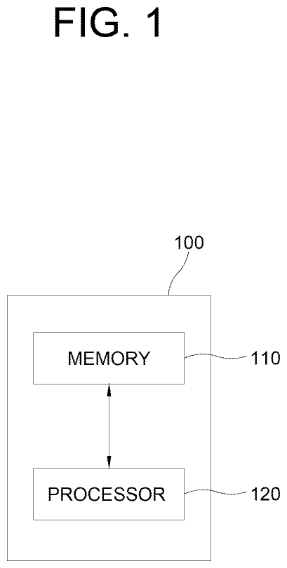

FIG. 1 is a drawing representing a schematic configuration of a server 100 for providing a battle royale game which allows players to repair their own protective items for survival in accordance with one example embodiment of the present disclosure, and the server 100 may include a memory 110 that stores instructions for providing the battle royale game which allows the players to repair the protective items for survival and a processor 120 configured to execute the instructions to perform or support another device to perform processes of providing the battle royale game which allows the players to repair the protective items for survival.

Specifically, the server 100 may typically achieve a desired system performance by using combinations of at least one computing device and at least one computer software, e.g., a computer processor, a memory, a storage, an input device, an output device, or any other conventional computing components, an electronic communication device such as a router or a switch, an electronic information storage system such as a network-attached storage (NAS) device and a storage area network (SAN) as the computing device and any instructions that allow the computing device to function in a specific way as the computer software.

Also, the processors of such devices may include hardware configuration of MPU (Micro Processing Unit) or CPU (Central Processing Unit), cache memory, data bus, etc. Additionally, the computing device may further include operating system (OS) and software configuration of applications that achieve specific purposes.

Such description of the computing device does not exclude an integrated device including any combination of a processor, a memory, a medium, or any other computing components for implementing the present disclosure.

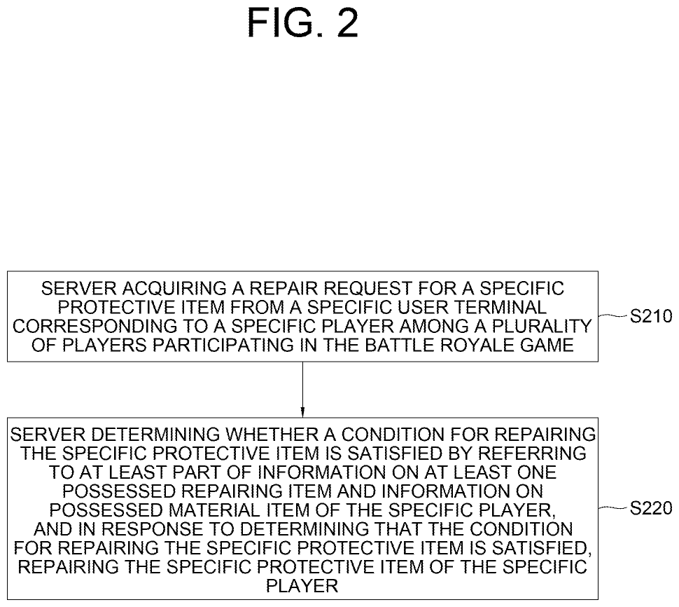

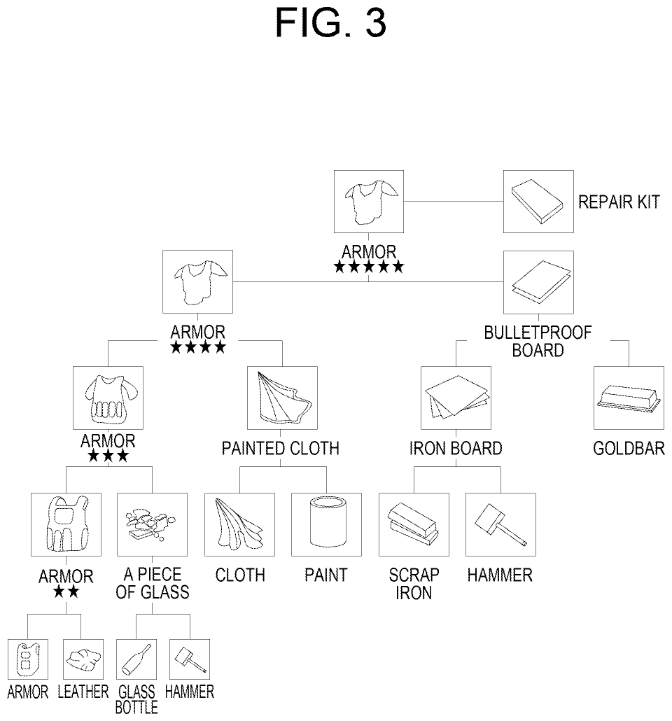

The method for providing the battle royale game which allows the players to repair the protective items for survival using the server 100 configured as above is explained by referring to FIGS. 2 and 3 as follows.

For reference, as used in this specification and the appended claims, the singular forms “a,” “an,” and “the” may include plural referents unless the content or the context clearly dictates otherwise.

FIG. 2 is a drawing representing a flowchart for providing the battle royale game which allows the players to repair the protective items for survival in accordance with one example embodiment of the present disclosure. Briefly explaining the overall flow of the present invention by referring to FIG. 2, the server 100 may acquire a repair request for a specific protective item from a specific user terminal corresponding to a specific player among the players participating in the battle royale game at a step of S210, and determine whether a condition for repairing the specific protective item is satisfied by referring to at least part of information on at least one possessed repairing item and information on possessed material item of the specific player, and in response to determining that the condition for repairing the specific protective item is satisfied, repair the specific protective item of the specific player at a step of S220.

Hereinafter, it will be explained in detail as to the processes of providing the battle royale game which allows the players to repair the protective items for survival in accordance with one example embodiment of the present disclosure.

Firstly, information on each of a 1-st protective item to an n-th protective item, information on each of at least one 1-st material item corresponding to the 1-st protective item to at least one n-th material item corresponding to the n-th protective item may be stored and managed in a database. For reference, each of the 1-st protective item to the n-th protective item is an item wearable by at least part of the players participating in the battle royale game, and for example, each of an armor, a helmet and a shield may be considered as the 1-st protective item to the n-th protective item.

However, types of the protective items are not limited to the above examples, and whatever items (for example, gloves, boots, etc.) for protecting the players, i.e., preventing or reducing damages to the players, may be the protective items. For example, the 1-st protective item may be a light weight armor, a 2-nd protective item may be a heavy weight armor, a 3-rd protective item may be a light weight helmet, a 4-th protective item may be a heavy weight helmet, a 5-th protective item may be a shield, a 6-th protective item may be a pair of gloves, a 7-th protective item may be a pair of boots.

In addition, each of the 1-st material item to the n-th material item to be consumed respectively for upgrading each of the 1-st protective item to the n-th protective item may include at least part of (i) each of a (1_1)-st material item to an (n_1)-st material item directly consumed respectively for upgrading each of the 1-st protective item to the n-th protective item and (ii) each of a (1_2)-nd material item to an (n_2)-nd material item indirectly consumed respectively for upgrading each of the 1-st protective item to the n-th protective item.

In addition, each of the 1-st hierarchy information to the n-th hierarchy information may include each of information on hierarchy between each of levels of the 1-st protective item and each of levels of the 1-st material item to information on hierarchy between each of levels of the n-th protective item and each of levels of the n-th material item.

Herein, at least part of the 1-st protective item to the n-th protective item may be classified as a plurality of levels. For example, a k-th protective item among the 1-st protective item to the n-th protective item may include a (k_1)-th level protective item to a (k_mk)-th level protective item. For reference, k may be an integer of 1 to n, and m may be an integer of 1 or more.

In addition, a k-th material item among the at least one 1-st material item to the at least one n-th material item may include at least part of a (k_1_1)-st material item directly consumed for upgrading the (k_1)-st level protective item and a (k_2_1)-st material item indirectly consumed for upgrading the (k_1)-st level protective item, at least part of a (k_1_2)-nd material item directly consumed for upgrading the (k_2)-nd level protective item and a (k_2_2)-nd material item indirectly consumed for upgrading the (k_2)-nd level protective item, . . . , and at least part of a (k_1_(m−1)k)-th material item directly consumed for upgrading the (k_(m−1)k)-th level protective item and a (k_2_(m−1)k)-th material item indirectly consumed for upgrading the (k_(m−1)k)-th level material item.

Below, in order to help the understanding of the k-th protective item, the k-th material item and the k-th hierarchy information, the explanation thereon is provided by referring to FIG. 3.

Referring to FIG. 3, as the k-th protective item, a protective item marked with “Armor” is shown. Herein, “Armor” item is the (k_1)-st level protective item to the (k_mk)-th level protective item, and may include a 1-st level “Armor” item to a 5-th level “Armor” item.

In addition, referring to FIG. 3, as the k-th material item consumed for upgrading “Armor” item which is the k-th protective item, “leather,” “a piece of glass,” “cloth,” “iron sheet” and “bulletproof board” items, etc. are shown.

Herein, each of “leather,” “a piece of glass,” “painted cloth” and “bulletproof board” serves as the k-th material item directly consumed for upgrading the 1-st level “Armor” item to a 4-th level “Armor” item, and thus each of “leather,” “a piece of glass,” “painted cloth” and “bulletproof board” corresponds to each of the (k_1_1)-st material item to a (k_1_4)-th material item.

In addition, each of (i) “a glass bottle,” “a hammer,” (ii) “cloth,” “paint,” (iii) “scrap iron,” “hammer,” “iron board” and “gold bar” serves as the k-th material item indirectly consumed for upgrading each of a 2-nd level “Armor” to the 4-th level “Armor”, and thus each of (i) “a glass bottle,” “a hammer,” (ii) “cloth,” “paint,” (iii) “scrap iron,” “hammer,” “iron board” and “gold bar” corresponds to each of the (k_2_2)-nd material item to a (k_2_4)-th material item.

In addition, referring to FIG. 3, as the k-th hierarchy information for “Armor” item which is the k-th protective item, information on relationships between each of levels of the 1-st “Armor” item to the 5-th “Armor” item and its corresponding material item.

In addition, the server 100 may acquire a repair request for a specific protective item from a specific user terminal corresponding to a specific player among the plurality of players participating in the battle royale game.

Herein, information on a 1-st threshold durability to information on an n-th threshold durability respectively corresponding to the 1-st protective item to the n-th protective item may be stored and managed in the database.

As an example, an initial durability of 140 may be set for a helmet item which is one of the 1-st protective item to the n-th protective item, and a threshold durability of 0 may be set for the helmet item, and when a current durability of the helmet item decreases to the threshold durability or below, a defense capacity of the helmet item may be lost.

Herein, a specific user who controls the specific player fails to recognize that the defense capacity of the helmet item was lost, and continues to control the specific player while the specific player is wearing the helmet item which has lost the defense capacity, the specific player may easily lose the battles with competitors.

In order to prevent such events from happening, in response to acquiring information on a current durability corresponding to the specific protective item from the specific user terminal, the server 100 compares the current durability with a specific threshold durability of the specific protective item, and in response to determining that the current durability is less than or equal to the specific threshold durability, the server 100 transmits information on a defense capacity loss which represents that the defense capacity of the specific protective item is lost to the specific user terminal. Therethrough, the server 100 supports the specific user terminal to transmit the repair request for the specific protective item by referring to the information on the defense capacity loss, and thus acquires the repair request for the specific protective item from the specific user terminal.

As one example, as the durability of the helmet item worn by the specific player is decreased due to an attack from a competitor, in response to determining that the current durability of the helmet item is less than or equal to the specific threshold durability, the server 100 may transmit information on the defense capacity loss of the helmet item by generating a visual effect that the helmet item pops up above the head of the specific player, thereby supporting the specific user terminal to transmit the repair request for the helmet item by referring to the information on the defense capacity loss.

In addition, the server 100 may determine whether a condition for repairing the specific protective item is satisfied by referring to at least part of information on at least one possessed repairing item and information on possessed material item of the specific player, and in response to determining that the condition for repairing the specific protective item is satisfied, it may repair the specific protective item of the specific player.

For reference, at least part of the repairing item and at least part of the material item may be identical items, but they are not limited thereto.

As one example, the information on the possessed repairing item may be information on an item, consumed for repairing at least part of the 1-st protective item to the n-th protective item, among the possessed items of the specific player.

Herein, the repairing item may include the repairing item (i.e., a so-called common repairing item) applied in common to at least part of the 1-st protective item to the n-th protective item, but it is not limited thereto, and may include the repairing item (i.e., a so-called exclusive repairing item) applied individually to each of the 1-st protective item to the n-th protective item.

In addition, the information on the possessed material item may be information on an item, consumed for upgrading at least part of the 1-st protective item to the n-th protective item, among the possessed items of the specific player.

For reference, the explanation on the material item was given by referring to FIG. 3, and thus the specific explanation thereon is omitted.

In the above, it was explained as to the repairing item and the material item, and below, it shall be explained as to whether the server 100 can support the specific user to request the specific protective item to be repaired by using what item among the repairing items and the material items.

As one example, the server 100 may provide at least one of a 1-st repair mode UI and a 2-nd repair mode UI to the specific user terminal, and thus may acquire at least one of a 1-st repair request corresponding to the 1-st repair mode UI and a 2-nd repair request corresponding to the 2-nd repair mode UI from the specific user terminal.

For reference, the 1-st repair mode UI may be a user interface provided for directly allowing the specific protective item to be repaired by consuming at least part of the possessed repairing item of the specific player.

In addition, the 2-nd repair mode UI may be a user interface provided for indirectly allowing the specific protective item to be repaired by consuming at least part of the possessed material item of the specific player and thus by upgrading the specific protective item.

For reference, indirectly repairing the specific protective item may mean that as a result of upgrading the level of the specific protective item, the durability of the specific protective item is also recovered.

In addition, the server 100 may perform processes below in case any one of the 1-st repair request and the 2-nd repair request is acquired.

As one example, in case the 1-st repair request is acquired, the server 100 may determine whether a condition for repairing a 1-st specific protective item is satisfied by referring to at least part of the possessed repairing item, according to the 1-st repair mode corresponding to the 1-st repair request.

In addition, in response to determining that the condition for repairing the 1-st specific protective item is satisfied, the server 100 may perform a direct repairing process of directly repairing the specific protective item by consuming at least part of the possessed repairing item of the specific player.

For another example, in case the 2-nd repair request is acquired, the server 100 may determine whether a condition for repairing a 2-nd specific protective item is satisfied by referring to (i) at least part of information on the 1-st protective item to the n-th protective item, information on the 1-st material item to the n-th material item and the 1-st hierarchy information to the n-th hierarchy information and (ii) at least part of the possessed material item, according to the 2-nd repair mode corresponding to the 2-nd repair request.

In addition, in response to determining that the condition for repairing the 2-nd specific protective item is satisfied, the server 100 may perform an indirect repairing process of indirectly repairing the specific protective item by consuming at least part of the possessed material item of the specific player and thus by upgrading the specific protective item.

Meanwhile, there may be a case where the specific user terminal transmits the 1-st repair request and the 2-nd repair request on the same protective item to the server 100.

As one example, the server 100 may provide the 1-st repair mode UI and the 2-nd repair mode UI to the specific user terminal and thus may acquire the 1-st repair request corresponding to the 1-st repair mode UI and the 2-nd repair request corresponding to the 2-nd repair mode UI from the specific user terminal.

In addition, the server 100 may determine a specific repair mode among the 1-st repair mode and the 2-nd repair mode by referring to (i) at least part of the possessed repairing item and the possessed material item, (ii) a 1-st process-performing probability which represents a probability of performing the direct repairing process capable of directly repairing the specific protective item according to the 1-st repair mode corresponding to the 1-st repair request and (iii) a 2-nd process-performing probability which represents a probability of performing an indirect repairing process capable of indirectly repairing the specific protective item according to the 2-nd repair mode corresponding to the 2-nd repair request.

Herein, the 1-st process-performing probability and the 2-nd process-performing probability may be determined according to each of past repairing patterns of each of the players participating in the battle royale game.

For example, on condition that 50 players identically have possessed the specific protective item and the repairing item and the material item for the specific protective item, according to the past repairing pattern of 20 players out of the 50 players transmitting the 1-st repair request corresponding to the 1-st repair mode UI to the server 100 and the past repairing pattern of the rest of 30 players transmitting the 2-nd repair request corresponding to the 2-nd repair mode UI to the server 100, the 1-st process-performing probability and the 2-nd process-performing probability may be determined as ⅖ and ⅗ respectively. In addition, the server 100 may determine a repair mode, calculated by a predetermined function having arguments of (i) at least part of information on the possessed repairing item and information on the possessed material item, (ii) the 1-st process-performing probability (e.g., ⅖) and (iii) the 2-nd process-performing probability (e.g., ⅗), as the specific repair mode.

Herein, in case the 1-st repair mode is determined as the specific repair mode, in response to determining that the condition for repairing the 1-st specific protective item is satisfied by referring to at least part of the possessed repairing item, the server 100 may perform the direct repairing process capable of directly repairing the 1-st specific protective item by consuming at least part of the possessed repairing item of the specific player.

In contrast, in case the 2-nd repair mode is determined as the specific repair mode, in response to determining that the condition for repairing the 2-nd specific protective item is satisfied by referring to (i) at least part of information on the 1-st protective item to the n-th protective item, information on the 1-st material item to the n-th material item and the 1-st hierarchy information to the n-th hierarchy information and (ii) at least part of the possessed material item, the server 100 may perform the indirect repairing process capable of indirectly repairing the 2-nd specific protective item by consuming at least part of the possessed material item of the specific player and thus by upgrading the specific protective item.

Meanwhile, in case of repairing the protective item through upgrading, the server 100 may impart a special skill to the upgraded protective item, and accordingly induce the users to actively search for material items for upgrading protective items, and causing battles to frequently occur among the players therethrough, thereby preventing the players from losing interest in the battle royale game.

As one example, the server 100 may acquire a repair request for a (k_(j−1)k)-th level protective item among the (k_1)-th level protective item to (k_(m−1)k)-th level protective item (as one example of the repair request for the specific protective item) from the specific user terminal. For reference, j may be an integer of 1 to m.

In addition, the server 100 may determine whether a condition for repairing the (k_(j−1)k)-th level protective item (as one example of the condition for repairing the specific protective item) is satisfied by referring to (i) at least part of information on the 1-st protective item to the n-th protective item, information on the 1-st material item to the n-th material item and the 1-st hierarchy information to the n-th hierarchy information and (ii) at least part of information on the possessed material item. In response to determining that the condition for repairing the (k_(j−1)k-th level protective item is satisfied, the server 100 may allow the specific player to repair the (k_(j−1)k)-th level protective item by upgrading the (k_(j−1)k)-th level protective item of the specific player to (k_jk)-th level protective item. For example, the server 100 may determine whether a condition for repairing a (10_2)-nd level protective item is satisfied by referring to (i) information on the (10_2)-nd level protective item (for example, 2-nd level protective item) and a (10−3)-rd level protective item as the at least part of information on 10-th protective items (for example, knee pads), (ii) at least part of information on a (10_1_2)-nd material item and a (10_2_2)-nd material item directly/indirectly consumed for upgrading the (10_2)-nd level protective item among the 10-th material items (for example, items for repairing and/or upgrading the knee pads) and (iii) at least part of 10-th hierarchy information and (iv) at least part of information on the possessed material item. In response to determining that the condition for repairing the (10_2)-nd level protective item is satisfied, the server 100 may repair the (10_2)-nd level protective item by upgrading the (10_2)-nd level protective item of the specific player to the (10_3)-rd level protective item.

Herein, the server 100 may impart a specific special skill among s special skills to the (k_jk)-th level protective item according to a special skill imparting probability. For reference, s may be an integer of 1 or more.

For reference, the specific special skill may be determined by the server 100 according to a predetermined algorithm among the s special skills.

In addition, the special skill imparting probability may be set to be corresponding to information on game progress level.

Assuming that a state of the plurality of players waiting in a waiting space in the battle royale game is a 1-st state and a state of the plurality of players playing in the battle royale game is a 2-nd state, the information on the game progress level may be calculated by using a progress level calculating function having arguments of at least part of (i) elapsed time information which represents a time elapsed after the battle royale game enters the 2-nd state, (ii) player battle power information which represents battle powers of at least part of the plurality of players, (iii) area phase information which represents a state of a safe area and a dangerous area being changed according to area metadata, (iv) a cardinal number of surviving players among the plurality of players and (v) possessed item of the surviving players.

For example, since it is usually difficult to collect the material items for upgrading protective items in the initial stage whereas it is usually easy to collect them by robbing some of massive material items collected by other players in the later stage, the serer 100 may set the special skill imparting probability to be decreased as the elapsed time increases. However, the example is merely for facilitating the understanding, and the present invention is not limited thereto.

Herein, in case the specific special skill is imparted to the (k_(j_1)k)-th level protective item, the server 100 may further impart an additional special skill among (s−1) special skills (excluding the specific special skill from the s special skills) to the (k_jk)-th level protective item according to the special skill imparting probability.

Meanwhile, each of classes may be imparted to each of players participating in the battle royale game, and a class synergetic protective item may exist for each of the classes. As one example, on condition that information on 1-st class synergetic protective item to j-th class synergetic protective item respectively corresponding to a 1-st class to a j-th class have been further stored and managed in the database, the server 100 may acquire a repair request for a specific class synergetic protective item corresponding to a specific class applied to the specific player (as one example of the repair request for the specific protective item) from the specific user terminal.

Herein, i may be an integer of 1 to j, and the 1-st class synergetic protective item to the j-th class synergetic protective item may be respectively any ones of the 1-st protective item to the n-th protective item. Further, the 1-st class synergetic protective item to the j-th class synergetic protective item may be items capable of improving performances thereof in case they are used by at least one 1-st player to at least one j-th player respectively corresponding to the 1-st class to the j-th class.

Herein, the meaning of the performances of the specific synergetic protective item being improved may represent that the defense capacity of the specific class synergetic protective item is improved, or a special skill is added to the specific class synergetic protective item.

However, the example for the performance improvement is merely an example to facilitate understanding, and the present invention is not limited thereto.

In addition, the server 100 may determine whether a condition for repairing the specific class synergetic protective item by referring to at least part of the possessed repair item and the possessed material item of the specific player, and in response to determining that the condition for repairing the specific class synergetic protective item is satisfied, the server 100 may repair the specific class synergetic protective item of the specific player.

The present disclosure has an effect of supporting the players participating in a battle royale game to be capable of repairing protective items necessary for survival by using various items.

The present disclosure has another effect of supporting the players to determine a manner of repairing the protective items in response to various situations occurring in the battle royale game, to thereby support the players to be capable of repairing the protective items through a suitable repairing manner for their own current situations.

The present disclosure has still another effect of providing various information on the protective items necessary for survival to the players through various visual effects. The present disclosure has still yet another effect of imparting the special skill to a repaired protective item, to thereby preventing the players of the battle royale game from losing interest easily.

Besides, the embodiments of the present disclosure as explained above can be implemented in a form of executable program command through a variety of computer means recordable to computer readable media. The computer readable media may store solely or in combination, program commands, data files, and data structures. The program commands recorded in the media may be components specially designed for the present disclosure or may be usable for a skilled human in a field of computer software. The computer readable media include, but are not limited to, magnetic media such as hard drives, floppy diskettes, magnetic tapes, memory cards, solid-state drives, USB flash drives, optical media such as CD-ROM and DVD, magneto-optical media such as floptical diskettes and hardware devices such as a read-only memory (ROM), a random access memory (RAM), and a flash memory specially designed to store and carry out program commands. Program commands may include not only a machine language code made by a compiler but also a high level code that can be used by an interpreter etc., which is executed by a computer. The aforementioned hardware device may work as more than a software module to perform the action of the present disclosure and they may do the same in the opposite case. As seen above, the present disclosure has been explained by specific matters such as detailed components, limited embodiments, and drawings. While the invention has been shown and described with respect to the preferred embodiments, it, however, will be understood by those skilled in the art that various changes and modification may be made without departing from the spirit and scope of the invention as defined in the following claims.

Accordingly, the thought of the present disclosure must not be confined to the explained embodiments, and the following patent claims as well as everything including variations equal or equivalent to the patent claims pertain to the category of the thought of the present disclosure.

What is claimed is:

1. A method for providing a battle royale game which allows the players to repair the protective items, comprising steps of:
(a) on condition that information on each of a 1-st protective item to an n-th protective item, information on at least one 1-st material item corresponding to the 1-st protective item to at least one n-th material item corresponding to the n-th protective item, wherein each of the 1-st material item to the n-th material item to be consumed respectively for upgrading each of the 1-st protective item to the n-th protective item includes at least part of (i) each of a (1_1)-st material item to an (n_1)-st material item directly consumed respectively for upgrading each of the 1-st protective item to the n-th protective item and (ii) each of a (1_2)-nd material item to an (n_2)-nd material item indirectly consumed respectively for upgrading each of the 1-st protective item to the n-th protective item, and 1-st hierarchy information to n-th hierarchy information, wherein each of the 1-st hierarchy information to the n-th hierarchy information includes each of information on hierarchy between each of levels of the 1-st protective item and each of levels of the 1-st material item to information on hierarchy between each of levels of the n-th protective item and each of levels of the n-th material item, have been stored and managed in a database, a server acquiring a repair request for a specific protective item from a specific user terminal corresponding to a specific player among a plurality of players participating in the battle royale game; and
(b) the server determining whether a condition for repairing the specific protective item is satisfied by referring to at least part of information on at least one possessed repairing item and information on possessed material item of the specific player, and in response to determining that the condition for repairing the specific protective item is satisfied, repairing the specific protective item of the specific player, wherein the information on the possessed repairing item is information on an item consumed for repairing at least part of the 1-st protective item to the n-th protective item, and wherein the information on the possessed material item is information on an item consumed for upgrading at least part of the 1-st protective item to the n-th protective item.

2. The method of claim 1, wherein, at the step of (a), the server provides at least one of a 1-st repair mode UI and a 2-nd repair mode UI to the specific user terminal, and thus acquires any one of a 1-st repair request corresponding to the 1-st repair mode UI and a 2-nd repair request corresponding to the 2-nd repair mode UI as the repair request for the specific protective item from the specific user terminal, wherein the 1-st repair mode UI is a user interface provided for directly allowing the specific protective item to be repaired by consuming at least part of the possessed repairing item of the specific player, and wherein the 2-nd repair mode UI is a user interface provided for indirectly allowing the specific protective item to be repaired by consuming at least part of the possessed material item of the specific player and thus by upgrading the specific protective item, and
wherein, at the step of (b), the server performs any one of (i) a direct repairing process of (i-1) determining whether a condition for repairing a 1-st specific protective item as the condition for repairing the specific protective item is satisfied by referring to at least part of the possessed repairing item and (i-2) in response to determining that the condition for repairing the 1-st specific protective item is satisfied, directly repairing the specific protective item by consuming at least part of the possessed repairing item of the specific player, in case the 1-st repair request is acquired, according to a 1-st repair mode corresponding to the 1-st repair request and (ii) an indirect repairing process of (ii-1) determining whether a condition for repairing a 2-nd specific protective item as the condition for repairing the specific protective item is satisfied by referring to (ii-1-a) at least part of information on the 1-st protective item to the n-th protective item, information on the 1-st material item to the n-th material item and the 1-st hierarchy information to the n-th hierarchy information and (ii-1-b) at least part of the possessed material item, and (ii-2) in response to determining that the condition for repairing the 2-nd specific protective item is satisfied, indirectly repairing the specific protective item by consuming at least part of the possessed material item of the specific player and thus by upgrading the specific protective item, in case the 2-nd repair request is acquired, according to a 2-nd repair mode corresponding to the 2-nd repair request.

3. The method of claim 1, wherein, at the step of (a), the server provides a 1-st repair mode UI and a 2-nd repair mode UI to the specific user terminal, wherein the 1-st repair mode UI is a user interface provided for directly allowing the specific protective item to be repaired by consuming at least part of the possessed repairing item of the specific player, and wherein the 2-nd repair mode UI is a user interface provided for indirectly allowing the specific protective item to be repaired by consuming at least part of the possessed material item of the specific player and thus by upgrading the specific protective item, and thus acquires a 1-st repair request corresponding to the 1-st repair mode UI and a 2-nd repair request corresponding to the 2-nd repair mode UI as the repair request for the specific protective item from the specific user terminal, and
wherein, at the step of (b), the server determines a specific repair mode among the 1-st repair mode and the 2-nd repair mode by referring to (i) at least part of the possessed repairing item and the possessed material item, (ii) a 1-st process-performing probability which represents a probability of performing a direct repairing process directly repairing the specific protective item according to a 1-st repair mode corresponding to the 1-st repair request and (iii) a 2-nd process-performing probability which represents a probability of performing an indirect repairing process indirectly repairing the specific protective item according to a 2-nd repair mode corresponding to the 2-nd repair request,
wherein, in case the 1-st repair mode is determined as the specific repair mode, in response to determining that a condition for repairing a 1-st specific protective item as the condition for repairing the specific protective item is satisfied by referring to at least part of the possessed repairing item, the server performs the direct repairing process directly repairing the specific protective item by consuming at least part of the possessed repairing item of the specific player, and
wherein, in case the 2-nd repair mode is determined as the specific repair mode, in response to determining that a condition for repairing a 2-nd specific protective item as the condition for repairing the specific protective item is satisfied by referring to (i) at least part of information on the 1-st protective item to the n-th protective item, information on the 1-st material item to the n-th material item and the 1-st hierarchy information to the n-th hierarchy information and (ii) at least part of the possessed material item, the server performs the indirect repairing process indirectly repairing the specific protective item by consuming at least part of the possessed material item of the specific player and thus by upgrading the specific protective item.

4. The method of claim 1, wherein a k-th protective item among the 1-st protective item to the n-th protective item includes a (k_1)-th level protective item to a (k_mk)-th level protective item, where k is an integer of 1 to n, and
wherein a k-th material item among the 1-st material item to the n-th material item includes at least part of a (k_1_1)-st material item directly consumed for upgrading the (k_1)-st level protective item and a (k_2_1)-st material item indirectly consumed for upgrading the (k_1)-st level protective item, at least part of a (k_1_2)-nd material item directly consumed for upgrading the (k_2)-nd level protective item and a (k_2_2)-nd material item indirectly consumed for upgrading the (k_2)-nd level protective item, . . . , and at least part of a (k_1_(m−1)k)-th material item directly consumed for upgrading the (k_(m−1)k)-th level protective item and a (k_2_(m−1)k)-th material item indirectly consumed for upgrading the (k_(m−1)k)-th level material item.

5. The method of claim 4, wherein, at the step of (a), the server acquires a repair request for a (k_(j−1)k)-th level protective item among the (k_1)-th level protective item to (k_(m−1)k)-th level protective item as the repair request for the specific protective item from the specific user terminal, where j is an integer of 1 to m, and
wherein, at the step of (b), the server determines whether a condition for repairing the (k_(j−1)k)-th level protective item as the condition for repairing the specific protective item is satisfied by referring to (i) at least part of information on the 1-st protective item to the n-th protective item, information on the 1-st material item to the n-th material item and the 1-st hierarchy information to the n-th hierarchy information and (ii) at least part of information on the possessed material item, and in response to determining that the condition for repairing the (k_(j−1)k-th level protective item is satisfied, repairs the (k_(j−1)k)-th level protective item by upgrading the (k_(j−1)k)-th level protective item of the specific player to (k_jk)-th level protective item, and
wherein the server (1) determines a special skill imparting probability by referring to game progress level information, wherein, on condition that a state of the plurality of players waiting in a waiting space in the battle royale game is a 1-st state, and a state of the plurality of players playing in the battle royale game is a 2-nd state, the game progress level information is calculated by using a progress level calculating function having arguments of at least part of elapsed time information which represents a time elapsed after the battle royale game enters the 2-nd state, player battle power information which represents a battle power of at least part of the plurality of players, area phase information which represents a state of a safe area and a dangerous area being changed according to area metadata, a cardinal number of surviving players among the plurality of players and possessed item of the surviving players, and (2) imparts a specific special skill among s special skills to the (k_jk)-th level protective item according to the special skill imparting probability, where s is an integer of 1 or more.

6. The method of claim 5, wherein, at the step of (b), in case the specific special skill is imparted to the (k_(j_1)k)-th level protective item, the server further imparts an additional special skill among (s−1) special skills excluding the specific special skill to the (k_jk)-th level protective item according to the special skill imparting probability.

7. The method of claim 1, wherein, at the step of (a), on condition that information on a 1-st threshold durability to information on an n-th threshold durability respectively corresponding to the 1-st protective item to the n-th protective item have been stored and managed in the database, in response to acquiring information on a current durability corresponding to the specific protective item from the specific user terminal, the server compares the current durability with a specific threshold durability of the specific protective item, and in response to determining that the current durability is less than or equal to the specific threshold durability, the server transmits information on a defense capacity loss which represents that a defense capacity of the specific protective item is lost to the specific user terminal, thereby supporting the specific user terminal to transmit the repair request for the specific protective item by referring to the information on the defense capacity loss.

8. The method of claim 1, wherein, at the step of (a), on condition that information on 1-st class synergetic protective item to j-th class synergetic protective item respectively corresponding to a 1-st class to a j-th class have been further stored and managed in the database through a process of matching an i-th class synergetic protective item to an i-th class, where i is an integer of 1 to j, and wherein the 1-st class synergetic protective item to the j-th class synergetic protective item are respectively any ones of the 1-st protective item to the n-th protective item, and wherein the 1-st class synergetic protective item to the j-th class synergetic protective item are items capable of improving performances thereof in case they are used by at least one 1-st player to at least one j-th player respectively corresponding to the 1-st class to the j-th class, the server acquires a repair request for a specific class synergetic protective item corresponding to a specific class applied to the specific player as the repair request for the specific protective item from the specific user terminal, and
wherein, at the step of (b), the server determines whether a condition for repairing the specific class synergetic protective item by referring to at least part of the possessed repair item and the possessed material item of the specific player, and in response to determining that the condition for repairing the specific class synergetic protective item is satisfied, the server repairs the specific class synergetic protective item of the specific player.

9. A server for providing a battle royale game which allows the players to repair the protective items, comprising:
at least one memory that stores instructions; and
at least one processor configured to execute the instructions to perform or support another device to perform processes of: (I) on condition that information on each of a 1-st protective item to an n-th protective item, information on at least one 1-st material item corresponding to the 1-st protective item to at least one n-th material item corresponding to the n-th protective item, wherein each of the 1-st material item to the n-th material item to be consumed respectively for upgrading each of the 1-st protective item to the n-th protective item includes at least part of (i) each of a (1_1)-st material item to an (n_1)-st material item directly consumed respectively for upgrading each of the 1-st protective item to the n-th protective item and (ii) each of a (1_2)-nd material item to an (n_2)-nd material item indirectly consumed respectively for upgrading each of the 1-st protective item to the n-th protective item, and 1-st hierarchy information to n-th hierarchy information, wherein each of the 1-st hierarchy information to the n-th hierarchy information includes each of information on hierarchy between each of levels of the 1-st protective item and each of levels of the 1-st material item to information on hierarchy between each of levels of the n-th protective item and each of levels of the n-th material item, have been stored and managed in a database, acquiring a repair request for a specific protective item from a specific user terminal corresponding to a specific player among a plurality of players participating in the battle royale game; and (II) determining whether a condition for repairing the specific protective item is satisfied by referring to at least part of information on at least one possessed repairing item and information on possessed material item of the specific player, and in response to determining that the condition for repairing the specific protective item is satisfied, repairing the specific protective item of the specific player, wherein the information on the possessed repairing item is information on an item consumed for repairing at least part of the 1-st protective item to the n-th protective item, and wherein the information on the possessed material item is information on an item consumed for upgrading at least part of the 1-st protective item to the n-th protective item.

10. The server of claim 9, wherein, at the process of (I), the processor provides at least one of a 1-st repair mode UI and a 2-nd repair mode UI to the specific user terminal, and thus acquires any one of a 1-st repair request corresponding to the 1-st repair mode UI and a 2-nd repair request corresponding to the 2-nd repair mode UI as the repair request for the specific protective item from the specific user terminal, wherein the 1-st repair mode UI is a user interface provided for directly allowing the specific protective item to be repaired by consuming at least part of the possessed repairing item of the specific player, and wherein the 2-nd repair mode UI is a user interface provided for indirectly allowing the specific protective item to be repaired by consuming at least part of the possessed material item of the specific player and thus by upgrading the specific protective item, and
wherein, at the process of (II), the processor performs any one of (i) a direct repairing process of (i-1) determining whether a condition for repairing a 1-st specific protective item as the condition for repairing the specific protective item is satisfied by referring to at least part of the possessed repairing item and (i-2) in response to determining that the condition for repairing the 1-st specific protective item is satisfied, directly repairing the specific protective item by consuming at least part of the possessed repairing item of the specific player, in case the 1-st repair request is acquired, according to a 1-st repair mode corresponding to the 1-st repair request and (ii) an indirect repairing process of (ii-1) determining whether a condition for repairing a 2-nd specific protective item as the condition for repairing the specific protective item is satisfied by referring to (ii-1-a) at least part of information on the 1-st protective item to the n-th protective item, information on the 1-st material item to the n-th material item and the 1-st hierarchy information to the n-th hierarchy information and (ii-1-b) at least part of the possessed material item, and (ii-2) in response to determining that the condition for repairing the 2-nd specific protective item is satisfied, indirectly repairing the specific protective item by consuming at least part of the possessed material item of the specific player and thus by upgrading the specific protective item, in case the 2-nd repair request is acquired, according to a 2-nd repair mode corresponding to the 2-nd repair request.

11. The server of claim 9, wherein, at the process of (I), the processor provides a 1-st repair mode UI and a 2-nd repair mode UI to the specific user terminal, wherein the 1-st repair mode UI is a user interface provided for directly allowing the specific protective item to be repaired by consuming at least part of the possessed repairing item of the specific player, and wherein the 2-nd repair mode UI is a user interface provided for indirectly allowing the specific protective item to be repaired by consuming at least part of the possessed material item of the specific player and thus by upgrading the specific protective item, and thus acquires a 1-st repair request corresponding to the 1-st repair mode UI and a 2-nd repair request corresponding to the 2-nd repair mode UI as the repair request for the specific protective item from the specific user terminal, and
wherein, at the process of (II), the processor determines a specific repair mode among the 1-st repair mode and the 2-nd repair mode by referring to (i) at least part of the possessed repairing item and the possessed material item, (ii) a 1-st process-performing probability which represents a probability of performing a direct repairing process directly repairing the specific protective item according to a 1-st repair mode corresponding to the 1-st repair request and (iii) a 2-nd process-performing probability which represents a probability of performing an indirect repairing process indirectly repairing the specific protective item according to a 2-nd repair mode corresponding to the 2-nd repair request,
wherein, in case the 1-st repair mode is determined as the specific repair mode, in response to determining that a condition for repairing a 1-st specific protective item as the condition for repairing the specific protective item is satisfied by referring to at least part of the possessed repairing item, the processor performs the direct repairing process directly repairing the specific protective item by consuming at least part of the possessed repairing item of the specific player, and
wherein, in case the 2-nd repair mode is determined as the specific repair mode, in response to determining that a condition for repairing a 2-nd specific protective item as the condition for repairing the specific protective item is satisfied by referring to (i) at least part of information on the 1-st protective item to the n-th protective item, information on the 1-st material item to the n-th material item and the 1-st hierarchy information to the n-th hierarchy information and (ii) at least part of the possessed material item, the processor performs the indirect repairing process indirectly repairing the specific protective item by consuming at least part of the possessed material item of the specific player and thus by upgrading the specific protective item.

12. The server of claim 9, wherein a k-th protective item among the 1-st protective item to the n-th protective item includes a (k_1)-th level protective item to a (k_mk)-th level protective item, where k is an integer of 1 to n, and
wherein a k-th material item among the 1-st material item to the n-th material item includes at least part of a (k_1_1)-st material item directly consumed for upgrading the (k_1)-st level protective item and a (k_2_1)-st material item indirectly consumed for upgrading the (k_1)-st level protective item, at least part of a (k_1_2)-nd material item directly consumed for upgrading the (k_2)-nd level protective item and a (k_2_2)-nd material item indirectly consumed for upgrading the (k_2)-nd level protective item, . . . , and at least part of a (k_1_(m−1)k)-th material item directly consumed for upgrading the (k_(m−1)k)-th level protective item and a (k_2_(m−1)k)-th material item indirectly consumed for upgrading the (k_(m−1)k)-th level material item.

13. The server of claim 12, wherein, at the process of (I), the processor acquires a repair request for a (k_(j−1)k)-th level protective item among the (k_1)-th level protective item to (k_(m−1)k)-th level protective item as the repair request for the specific protective item from the specific user terminal, where j is an integer of 1 to m, and
wherein, at the process of (II), the processor determines whether a condition for repairing the (k_(j−1)k)-th level protective item as the condition for repairing the specific protective item is satisfied by referring to (i) at least part of information on the 1-st protective item to the n-th protective item, information on the 1-st material item to the n-th material item and the 1-st hierarchy information to the n-th hierarchy information and (ii) at least part of information on the possessed material item, and in response to determining that the condition for repairing the (k_(j−1)k-th level protective item is satisfied, repairs the (k_(j−1)k)-th level protective item by upgrading the (k_(j−1)k)-th level protective item of the specific player to (k_jk)-th level protective item, and
wherein the processor (I) determines a special skill imparting probability by referring to game progress level information, wherein, on condition that a state of the plurality of players waiting in a waiting space in the battle royale game is a 1-st state, and a state of the plurality of players playing in the battle royale game is a 2-nd state, the game progress level information is calculated by using a progress level calculating function having arguments of at least part of elapsed time information which represents a time elapsed after the battle royale game enters the 2-nd state, player battle power information which represents a battle power of at least part of the plurality of players, area phase information which represents a state of a safe area and a dangerous area being changed according to area metadata, a cardinal number of surviving players among the plurality of players and possessed item of the surviving players, and (II) imparts a specific special skill among s special skills to the (k_jk)-th level protective item according to the special skill imparting probability, where s is an integer of 1 or more.

14. The server of claim 13, wherein, at the process of (II), in case the specific special skill is imparted to the (k_(j_1)k)-th level protective item, the processor further imparts an additional special skill among (s−1) special skills excluding the specific special skill to the (k_jk)-th level protective item according to the special skill imparting probability.

15. The server of claim 9, wherein, at the process of (I), on condition that information on a 1-st threshold durability to information on an n-th threshold durability respectively corresponding to the 1-st protective item to the n-th protective item have been stored and managed in the database, in response to acquiring information on a current durability corresponding to the specific protective item from the specific user terminal, the processor compares the current durability with a specific threshold durability of the specific protective item, and in response to determining that the current durability is less than or equal to the specific threshold durability, the processor transmits information on a defense capacity loss which represents that a defense capacity of the specific protective item is lost to the specific user terminal, thereby supporting the specific user terminal to transmit the repair request for the specific protective item by referring to the information on the defense capacity loss.

16. The server of claim 9, wherein, at the process of (I), on condition that information on 1-st class synergetic protective item to j-th class synergetic protective item respectively corresponding to a 1-st class to a j-th class have been further stored and managed in the database through a process of matching an i-th class synergetic protective item to an i-th class, where i is an integer of 1 to j, and wherein the 1-st class synergetic protective item to the j-th class synergetic protective item are respectively any ones of the 1-st protective item to the n-th protective item, and wherein the 1-st class synergetic protective item to the j-th class synergetic protective item are items capable of improving performances thereof in case they are used by at least one 1-st player to at least one j-th player respectively corresponding to the 1-st class to the j-th class, the processor acquires a repair request for a specific class synergetic protective item corresponding to a specific class applied to the specific player as the repair request for the specific protective item from the specific user terminal, and
wherein, at the process of (II), the processor determines whether a condition for repairing the specific class synergetic protective item by referring to at least part of the possessed repair item and the possessed material item of the specific player, and in response to determining that the condition for repairing the specific class synergetic protective item is satisfied, the processor repairs the specific class synergetic protective item of the specific player.
